(19) United States
(12) Patent Application Publication
(10) Pub. No.: US 2015/0066586 A1
(43) Pub. Date: Mar. 5, 2015

(54) EVALUATION CALCULATING DEVICE, EVALUATION CALCULATING METHOD, AND RECORDING MEDIUM

(71) Applicant: Yahoo Japan Corporation, Tokyo (JP)

(72) Inventors: Teruhiko TERAOKA, Tokyo (JP); Masajiro IWASAKI, Tokyo (JP)

(73) Assignee: Yahoo Japan Corporation, Tokyo (JP)

(21) Appl. No.: 14/019,965

(22) Filed: Sep. 6, 2013

(30) Foreign Application Priority Data
Aug. 28, 2013 (JP) 2013-176867

(51) Int. Cl. G06Q 30/02

(52) U.S. Cl. CPC G06Q 30/0201
USPC 705/7.29

(57) ABSTRACT

A delivery device according to the present invention includes a storing unit and a calculating unit. The storing unit stores a number of views a webpage concerning a commercial product and a number of behaviors which result in profitable behavior which leads a profit of a provider who provides the webpage by the user who accesses the webpage in a memory unit for every commercial product. The calculating unit calculates an evaluation value of the commercial product based on the number of views the webpage concerning the commercial product and the number of behaviors of the webpage stored in the memory unit.

### CROSS-REFERENCE TO RELATED APPLICATIONS

The present application claims priority to and incorporates by reference the entire contents of Japanese Patent Application No. 2013-176867 filed in Japan on Aug. 28, 2013.

### BACKGROUND OF THE INVENTION

1. Field of the Invention

The present invention relates to an evaluation calculating device, an evaluation calculating method, and a recording medium.

2. Description of the Related Art

Recently, online shopping through the Internet is commonly spread. As a technique regarding online shopping, a technology which ranks a commercial product introducing page that treats a commercial product which is highly likely to be purchased by a user at a high level of a searching result is known. For example, with reference to commercial product attributes of the purchased commercial product, a technique which calculates a score that evaluates the commercial product attributes which are highly likely to be purchased by the user for every searching query and generates a ranking of the searching result for every searching query is known.
Patent Document 1: Japanese Patent Application Laid-open No. 2012-203821

However, in the related art, it is limited to appropriately evaluate the commercial product. Specifically, in the above-mentioned technique, commercial product attributes which contribute to the purchasing motivation of a user are evaluated so that the evaluation for the commercial product itself may not be suitable for the user. Therefore, it is limited to appropriately evaluate the commercial product in the related art.

### SUMMARY OF THE INVENTION

It is an object of the present invention to at least partially solve the problems in the conventional technology.

The above and other objects; features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram illustrating an example of evaluation processing according to a first exemplary embodiment.

FIG. 2 is a diagram illustrating a configuration example of a delivery system according to the first exemplary embodiment.

FIG. 3 is a diagram illustrating a configuration example of a delivery device according to the first exemplary embodiment.

FIG. 4 is a diagram illustrating an example of commercial product information memory unit according to the first exemplary embodiment.

FIG. 5 is a diagram illustrating an example of a commercial product page according to the first exemplary embodiment.

FIG. 6 is a flowchart illustrating a calculation processing procedure by the delivery device according to the first exemplary embodiment.

FIG. 7 is a flowchart illustrating an evaluation processing procedure by the delivery device according to the first exemplary embodiment.

FIG. 8 is an explanatory diagram illustrating an example of evaluation processing according to a modified embodiment.

FIG. 9 is a diagram illustrating an example of a commercial product information memory unit according to the modified embodiment.

FIG. 10 is a diagram illustrating an example of a social graph according to the modified embodiment.

FIG. 11 is a diagram illustrating a configuration example of a delivery device according to a second exemplary embodiment.

FIG. 12 is a diagram illustrating an example of a reason information memory unit according to the second exemplary embodiment.

FIG. 13 is a diagram illustrating an example of a reception screen according to the second exemplary embodiment.

FIG. 14 is a diagram illustrating an example of a reception screen according to the second exemplary embodiment.

FIG. 15 is a diagram illustrating an example of a comparison page according to the second exemplary embodiment.

FIG. 16 is a hardware configuration diagram illustrating an example of a computer which implements a function of the delivery device.

### DETAILED DESCRIPTION OF THE PREFERRED EMBODIMENTS

Hereinafter, embodiments (hereinafter, referred to as “exemplary embodiments”) for carrying out an evaluation calculating device, an evaluation calculating method, and a recording medium according to the present application will be described in detail with reference to the drawings. However, the evaluation calculating device, the evaluation calculating method, and the recording medium according to the present application are not limited by the exemplary embodiments. Further, like parts in respective exemplary embodiments are denoted by like reference numerals and redundant description will be avoided.

### First Exemplary Embodiment

### 1-1. Evaluation Processing

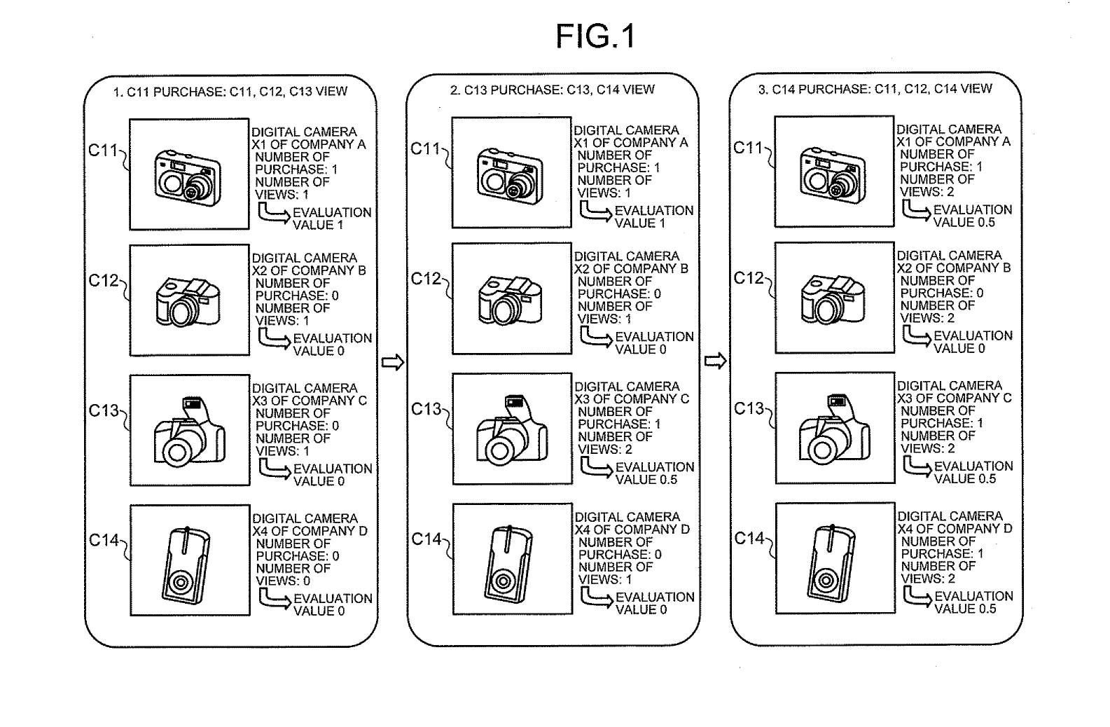

First, an example of evaluation processing according to a first exemplary embodiment will be described with reference to FIG. 1. FIG. 1 is an explanatory diagram illustrating an example of evaluation processing according to the first exemplary embodiment. In FIG. 1, the evaluation processing is performed by a delivery device 100 which will be described below.

The delivery device 100 provides a commercial product page through which a commercial product is introduced. Further, the delivery device 100 stores a number of purchases that the commercial product is purchased and a number of views that the commercial product page is viewed by a user for every commercial product. Further, the delivery device 100 stores the number of views when the commercial product page is viewed but the commercial product is not purchased.

In an example of the left side of FIG. 1, the delivery device 100 stores information on commercial products C11 to C14. Here, it is assumed that commercial product pages of the commercial products C11, C12, and C13 are viewed by one user. Further, it is assumed that the commercial product C11 among the viewed commercial products C11 to C13 is purchased by the user. In this case, “1” is stored as the number of purchases of the commercial product C11 which is stored in the delivery device 100. Furthermore, “1” is stored as the number of views of the commercial product C11 which is stored in the delivery device 100. Further, “0” is stored as the number of purchases of the commercial product C12 which is stored in the delivery device 100. Furthermore, “1” is stored as the number of views of the commercial product C12 which is stored in the delivery device 100. Further, “0” is stored as the number of purchases of the commercial product C13 which is stored in the delivery device 100. Furthermore, “1” is stored as the number of views of the commercial product C13 which is stored in the delivery device 100. Further, “0” is stored as the number of purchases of the commercial product C14 which is stored in the delivery device 100. Furthermore, “0” is stored as the number of views of the commercial product C14 which is stored in the delivery device 100. As described above, the delivery device 100 stores information on the commercial product C12 and the commercial product C13 of a commercial product page group which has been viewed for a predetermined period until the commercial product C11 is purchased together with information on the purchased commercial product C11.

The delivery device 100 calculates an evaluation value for every stored commercial product. In the exemplary embodiment, the evaluation value indicates, for example, information obtained based on the number of purchases of the commercial product or the number of views. Specifically, the delivery device 100 calculates the evaluation value of the commercial product by dividing the number of purchases by the number of views. For example, the delivery device 100 calculates the evaluation value “1” of the commercial product by dividing the number “1” of purchases of the commercial product C11 by the number “1” of views. Further, the delivery device 100 calculates the evaluation value “0” of the commercial product by dividing the number “0” of purchases of the commercial product C12 by the number “1” of views. Furthermore, the delivery device 100 calculates the evaluation value “0” of the commercial product by dividing the number “0” of purchases of the commercial product C13 by the number “1” of views.

When the number of views of the commercial product is “0”, the delivery device 100 calculates the evaluation value of the commercial product as “0”. For example, since the number of views is “0” in the case of the commercial product C14, the delivery device 100 calculates “0” as the evaluation value of the commercial product.

Next, as illustrated in the center of FIG. 1, it is assumed that the commercial product pages of the commercial products C13 and C14 are viewed by the user. Further, it is assumed that the commercial product C13 among the viewed commercial products C13 to C14 is purchased by the user. In this case, “1” is added to the number of purchases of the commercial product C13 which is stored in the delivery device 100, so that “1” is stored. Further, “1” is added to the number of views of the commercial product C13 which is stored in the delivery device 100, so that “2” is stored. Further, “1” is added to the number of views of the commercial product C14 which is stored in the delivery device 100, so that “1” is stored.

The delivery device 100 calculates “0.5” as the evaluation value of the commercial product by dividing the number “1” of purchases of the commercial product C13 which is stored in the delivery device 100 by the number of views “2”. Further, the delivery device 100 calculates “0” as the evaluation value of the commercial product by dividing the number “0” of purchases of the commercial product C14 which is stored in the delivery device 100 by the number of views “1”.

Next, as illustrated in the right side of FIG. 1, it is assumed that the commercial product pages of the commercial products C11, C12, and C14 are viewed by the user. Further, it is assumed that the commercial product C14 among the viewed commercial products C11, C12, and C14 is purchased by the user. In this case, “1” is added to the number of views of the commercial product C11 which is stored in the delivery device 100, so that “2” is stored. “1” is added to the number of views of the commercial product C12 which is stored in the delivery device 100, so that “2” is stored. “1” is added to the number of purchases of the commercial product C14 which is stored in the delivery device 100, so that “1” is stored. “1” is added to the number of views of the commercial product C14 which is stored in the delivery device 100, so that “2” is stored.

The delivery device 100 divides the number of purchases “1” of the commercial product C11 stored in the delivery device 100 by the number “2” of views to calculate the evaluation value “0.5” of the commercial product. Further, the delivery device 100 divides the number of purchases “0” of the commercial product C12 stored in the delivery device 100 by the number “2” of views to calculate the evaluation value “0” of the commercial product. Furthermore, the delivery device 100 divides the number of purchases “1” of the commercial product C14 stored in the delivery device 100 by the number “2” of views to calculate the evaluation value “0.5” of the commercial product.

Now, in the examples illustrated in the left side, the center, and the right side of FIG. 1, the purchasing and the views may be performed by the same user or different users.

As described above, the delivery device 100 according to the first exemplary embodiment calculates the evaluation value of the commercial product based on the number of purchases and the number of views of the commercial product for every commercial product. By doing this, the delivery device 100 calculates the evaluation value supported by actual behavior of the user so that the commercial product may be appropriately evaluated with a high credibility. That is, the delivery device 100 may increase accuracy of the evaluation value of the commercial product.

Specifically, in the example of the left side of FIG. 1, the commercial products C11 to C13 are viewed by the user and the commercial product C11 is purchased. That is, the user compares the commercial products C11 to C13 and selects the commercial product C11 to be purchased. Further, in the example of FIG. 1, the commercial product C11 is compared with the other commercial products in the example of the left side and the example of the right side of FIG. 1 so that the commercial product C11 becomes an object to be evaluated two times in total and is purchased one time. Further, in the example of FIG. 1, the commercial product C13 is compared in the examples of the left side and the center of FIG. 1, the commercial product C13 becomes an object to be evaluated two times in total and is purchased one time. That is, the number of times that the commercial product is compared corresponds to the number of views. Further, the number of times that the commercial product is selected by the user among the number of times that the commercial product is compared corresponds to the number of purchases.

By doing this, the delivery device 100 calculates the evaluation value of the commercial product to be low as the number of times that the commercial product becomes the object to be evaluated is increased and calculates the evaluation value of the commercial product to be high as the number of times that the commercial product is selected is increased so that it is possible to appropriately evaluate the commercial product.

### 1-2. Configuration of Delivery System

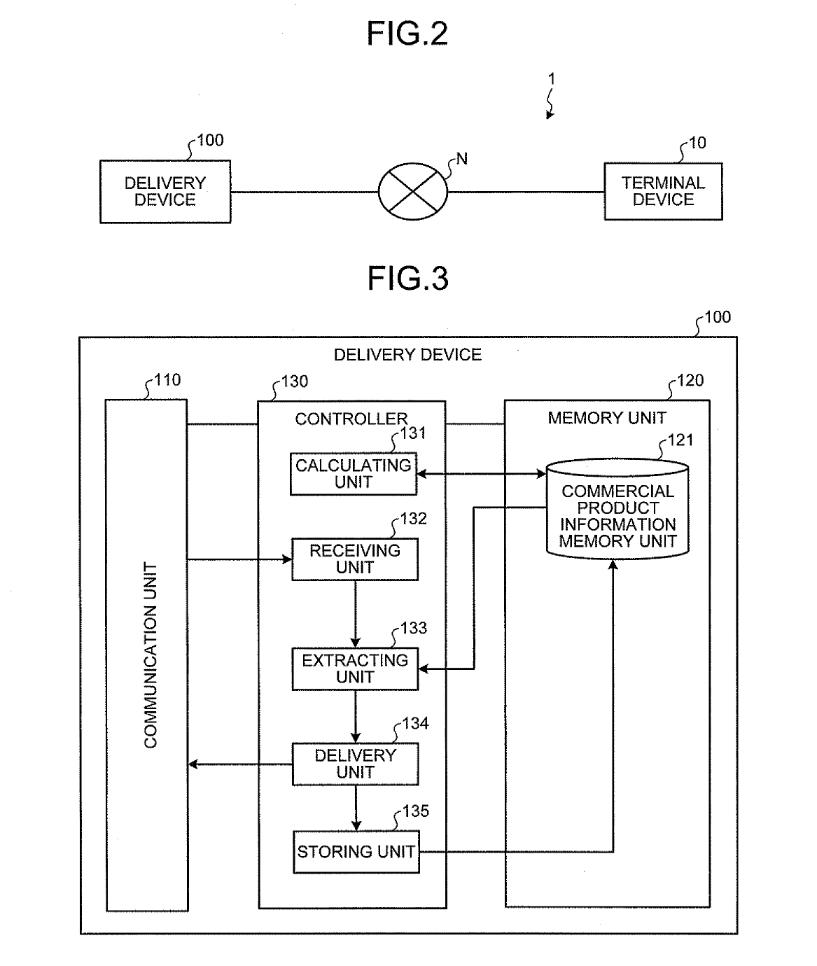

Next, a configuration of the delivery system according to the first exemplary embodiment will be described with reference to FIG. 2. FIG. 2 is a diagram illustrating a configuration example of the delivery system according to the first exemplary embodiment. As illustrated in FIG. 2, a delivery system 1 includes a terminal device 10 and the delivery device 100. The terminal device 10 and the delivery device 100 are connected through a network N so as to be communicable with each other in a wired or wireless manner. Further, the delivery system 1 illustrated in FIG. 2 may include a plurality of terminal devices 10 or a plurality of delivery devices 100.

The terminal device 10 is, for example, an information processing device such as a desktop PC (personal computer), a notebook PC, a tablet type terminal, a smart phone, a mobile phone, or a PDA (personal digital assistant). For example, the terminal device 10 accesses the delivery device 100 to obtain a webpage from the delivery device 100 and displays the obtained webpage on a display device (for example, a liquid crystal display).

The delivery device 100 is a server device which delivers a webpage. The webpage which is provided by the delivery device 100 includes various webpages concerning, for example, a shopping site, an auction site, a restaurant recommendation site, or a travel site. Specifically, when the delivery device 100 is accessed by the terminal device 10, the delivery device 100 delivers the commercial product page to the terminal device 10. Further, in the commercial product page, for example, a ranking frame which indicates a popular commercial product or a recommend frame which recommends the commercial product to the user is provided. In the recommend frame, a still image, a moving image, or text data into which URL (uniform resource locator) for accessing the commercial product page is embedded are displayed. For example, the delivery device 100 delivers the commercial product page in which a commercial product having a high evaluation value of the commercial product is displayed in priority to other products on the recommend frame to the terminal device 10.

### 1-3. Configuration of Delivery Device

Next, a configuration of the delivery device according to the first exemplary embodiment will be described with reference to FIG. 3. FIG. 3 is a diagram illustrating a configuration example of the delivery device according to the first exemplary embodiment. As illustrated in FIG. 3, the delivery device 100 includes a communication unit 110, a memory unit 120, and a controller 130. The delivery device 100 may also include an input unit (for example, a keyboard or a mouse) through which various manipulations from a manager who uses the delivery device 100 or a display unit (for example, a liquid crystal display) which displays various information.

Regarding Communication Unit 110

The communication unit 110 is embodied by an NIC (network interface card). The communication unit 110 is connected with the network N in a wired or wireless manner to transmit and receive information to and from the terminal device 10 through the network N.

Regarding Memory Unit 120

The memory unit 120 is embodied by a semiconductor memory device such as an RAM (random access memory) or a flash memory or a storing device such as a hard disk or an optical disk. The memory unit 120 includes a commercial product information memory unit 121, as illustrated in FIG. 3.

Commercial Product Information Memory Unit 121

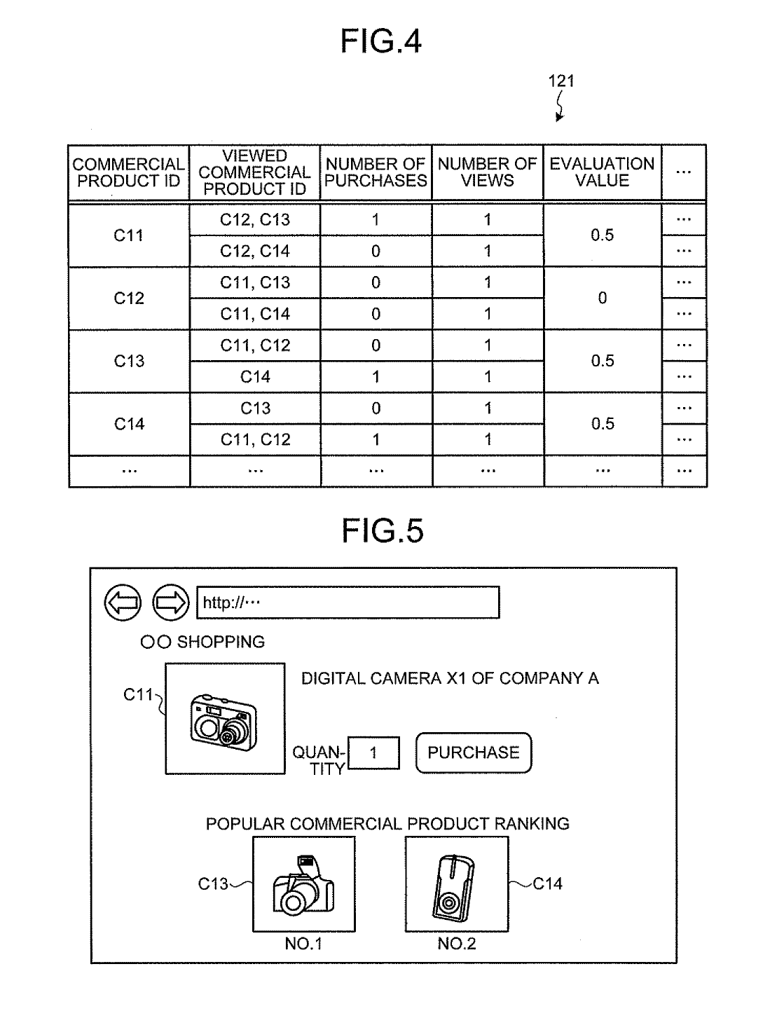

The commercial product information memory unit 121 stores information regarding the commercial product. Here, FIG. 4 illustrates an example of the commercial product information memory unit 121 according to the first exemplary embodiment. In the example illustrated in FIG. 4, the commercial product information memory unit 121 has items of a “commercial product ID”, a “viewed commercial product ID”, a “number of purchases”, a “number of views”, and an “evaluation value”.

The “commercial product ID” indicates identification information which identifies the commercial product. The “viewed commercial product ID” indicates a “commercial product ID” of other commercial product which is viewed in a predetermined period. The “number of purchases” indicates the number of times that the commercial product is purchased by the user. The “number of views” indicates the number of times that the commercial product page is viewed by the user. For example, in the “number of views”, a total value of the number of being accessed to the commercial product page by the user is stored. The “evaluation value” indicates a degree of popularity of the commercial product. For example, the larger the evaluation value, the higher the popularity so that the commercial product is likely to be purchased by the user. A calculating example of the “evaluation value” will be described below.

That is, FIG. 4 illustrates an example in which within a predetermined period, the commercial product page of the commercial product ID “C11”, “C12”, and “C13” is viewed by one user. Further, FIG. 4 illustrates an example in which the commercial product C11 among the commercial products C11 to C13, which are viewed by the user, is purchased by the user. Therefore, as illustrated in FIG. 4, the number of purchases of the commercial product ID “C11” when the viewed commercial product IDs are “C12” and “C13” is “1”. Further, the number of views of the commercial product ID “C11” when the viewed commercial product IDs are “C12” and “C13” is “1”.

Further, FIG. 4 illustrates an example in which within a predetermined period, the commercial product pages of the commercial product ID “C11”, “C12”, and “C14” are viewed by one user. Further, FIG. 4 illustrates an example in which the commercial product C14 among the commercial products C11, C12, and C14, which are viewed by the user, is purchased by the user. Therefore, as illustrated in FIG. 4, the number of purchases of the commercial product ID “C11” when the viewed commercial product IDs are “C12” and “C14” is “0”. Further, the number of views of the commercial product ID “C11” when the viewed commercial product IDs are “C12” and “C14” is “1”. Further, FIG. 4 illustrates an example in which an evaluation value of the commercial product C11 is “0.5”.

Further, each record which is stored in the commercial product information memory unit 121 is not limited to products which are viewed and purchased by the same user but may include products which are viewed and purchased by different users.

Further, in the example of FIG. 4, even though one commercial product among commercial products which are viewed by the user is purchased, an example in which a plurality of commercial products among commercial products which are viewed by the user are purchased may be applied. In this case, the commercial product information memory unit 121 updates the number of purchases and the number of views between the purchased commercial product and a commercial product which are viewed but not purchased without updating the number of purchasing and the number of views of the purchased commercial products among the viewed commercial products and the commercial products which are viewed but not purchased. However, the exemplary is not limited to the example, but the commercial product information memory unit 121 may store information on the purchased commercial products among the viewed commercial products and the commercial products which are viewed but not purchased.

Regarding Controller 130

The controller 130 is implemented when various programs (corresponding to an example of an evaluation calculating program) which are stored in a storage device in the delivery device 100 executes an RAM as an operating area by a CPU (central processing unit) or an MPU (micro processing unit)ed. Further, the controller 130 may be implemented by an integrated circuit such as an ASIC (application specific integrated circuit) or an FPGA (field programmable gate array).

Such the controller 130, as illustrated in FIG. 3, includes a calculating unit 131, a receiving unit 132, an extracting unit 133, a delivery unit 134, and a storing unit 135, and a function or an operation of information processing which will be described below implements or executes. An internal configuration of the controller 130 is not limited to a configuration illustrated in FIG. 3, but may have another configuration as long as information processing which will be described below is performed. Further, a connection relationship of processing units of the controller 130 is not limited to a connection relationship illustrated in FIG. 3, but may have other connection relationship.

Calculating Unit 131

The calculating unit 131 calculates an evaluation value of the commercial product based on the number of purchases and the number of views of the commercial product stored in the commercial product information memory unit 121. Specifically, the evaluation value which is calculated by the calculating unit 131 is larger when the commercial product is likely to be purchased or is more popular. In other words, the evaluation value to be calculated is smaller when the commercial product is hard to be purchased and is less popular.

For example, the calculating unit 131 calculates the evaluation value of the commercial product by dividing a total value of the number of purchases of the commercial product by a total value of the number of views per commercial product. In FIG. 4, the calculating unit 131 calculates an evaluation value “0.5” by dividing a total value “1” of the number of purchases of a commercial product having a commercial product ID “C11” by a total value “2” of the number of views. Similarly, the calculating unit 131 calculates an evaluation value “0” of a commercial product having a commercial product ID “C12”, an evaluation value “0.5” of a commercial product having a commercial product ID “C13”, and an evaluation value “0.5” of a commercial product having a commercial product ID “C14”.

Further, when the number of views of the commercial product is “0”, the calculating unit 131 calculates the evaluation value of the commercial product as “0”.

Regarding Receiving Unit 132

The receiving unit 132 receives an acquisition request for the commercial product page from the terminal device 10. For example, the receiving unit 132 receives the acquisition request for the commercial product page by an HTTP (hypertext transfer protocol) request.

Regarding Extracting Unit 133

When the acquisition request for the commercial product page is received by the receiving unit 132, the extracting unit 133 extracts a commercial product which is displayed in the ranking frame which shows a popular commercial product from the commercial product information memory unit 121 based on the evaluation value calculated by the calculating unit 131. Specifically, when the acquisition request for the commercial product page is received, the extracting unit 133 extracts the commercial product which is displayed in descending order of an evaluation value in the ranking frame. The extracting unit 133 outputs the commercial product page in which a ranking, which arranges the extracted commercial products in descending order of an evaluation value, is incorporated to the delivery unit 134.

An example of an extraction processing by the extracting unit 133 will be described using the commercial product information memory unit 121 illustrated in FIG. 4. For example, as illustrated in FIG. 4, it is assumed that an evaluation value “0.5” of the commercial product ID “C11”, an evaluation value “0” of the commercial product ID “C12”, an evaluation value “0.5” of the commercial product ID “C13”, and an evaluation value “0.5” of the commercial product ID “C14” are calculated by the calculating unit 131. Further, it is assumed that the user accesses the commercial product page of the commercial product ID “C11”. In this case, the extracting unit 133 extracts commercial products of the commercial product ID “C13” and the commercial product ID “C14” whose evaluation value “0.5” is the highest value as a commercial product which may be displayed in the ranking frame included in the commercial product page of the commercial product ID “C11”. The extracting unit 133 outputs the commercial product page in which a ranking, which arranges the extracted commercial products of the commercial product ID “C13” and the commercial product ID “C14” in descending order of an evaluation value, is incorporated to the delivery unit 134. When the evaluation values are equal to each other, for example, a commercial product having a larger number of most recent purchases is arranged in a higher rank.

Further, the extracting unit 133 may extract the commercial product which is displayed in a recommend frame of the commercial product page to be delivered from the commercial product information memory unit 121. In this case, a commercial product having a higher evaluation value may be extracted from commercial products which are simultaneously viewed. Specifically, when the acquisition request for the commercial product page is received, the extracting unit 133 extracts the commercial products which are arranged in descending order of the evaluation value in the recommend frame. Further, when the commercial product is extracted, the extracting unit 133 extracts the commercial product having the highest evaluation value commercial product with the exception of the commercial product of the commercial product page which is accessed by the user. The extracting unit 133 outputs the commercial product page in which the extracted commercial product is incorporated in the recommend frame to the delivery unit 134.

Regarding Delivery Unit 134

The delivery unit 134 delivers the commercial product page in which the commercial product extracted by the extracting unit 133 is incorporated in the ranking frame or the recommend frame to the terminal device 10 which is a transmission source of the acquisition request received by the receiving unit 132.

FIG. 5 is a diagram illustrating an example of the commercial product page according to the first exemplary embodiment. As illustrated in FIG. 5, in the commercial product page, the commercial product C11 is displayed in the commercial product page, and the commercial product C13 and the commercial product C14 which are extracted by the extracting unit 133 is displayed in the ranking frame. In an example of FIG. 5, it is assumed that the number of most recent purchases of the commercial product C13 is larger than that of the commercial product C14. In this case, as illustrated in FIG. 5, the commercial product C13 is displayed in a frame of ranking No. 1 and the commercial product C14 is displayed in a frame of ranking No. 2. Further, in an example of FIG. 5, for example, when the commercial product C13 is clicked, the page is migrated into the commercial product page of the commercial product C13.

Regarding Storing Unit 135

The storing unit 135 updates information which is stored in the commercial product information memory unit 121. Specifically, whenever the commercial product is purchased, the storing unit 135 updates the number of purchases which is stored in the commercial product information memory unit 121. Further, whenever the commercial product is viewed, the storing unit 135 updates the number of views which is stored in the commercial product information memory unit 121.

For example, within a predetermined period, it is assumed that the commercial products C11 to C13 are viewed by one user and the commercial product C11 is purchased by the same user. In this case, the storing unit 135 updates a first record, a third record, and a fifth record illustrated in the drawing. Specifically, the storing unit 135 updates the number purchases and the number of views by storing “1” in the number of purchases and the number of views of the commercial product ID “C11”, the viewed commercial product IDs “C12” and “C13”. Further, the storing unit 135 updates the number purchases and the number of views by storing “0” in the number of purchases and “1” in the number of views of the commercial product ID “C12”, the viewed commercial product IDs “C11” and “C13”. Furthermore, the storing unit 135 updates the number purchases and the number of views by storing “0” in the number of purchases and “1” in the number of views of the commercial product ID “C13”, the viewed commercial product IDs “C11” and “C12”.

### 1-4. Calculation Processing Procedure

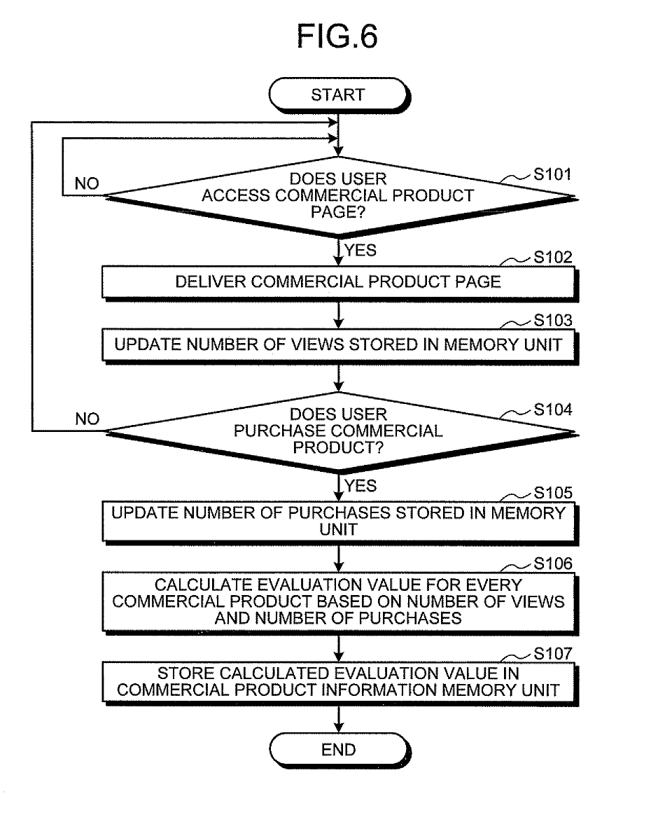

Next, a procedure of the calculation processing by the delivery device according to the first exemplary embodiment will be described with reference to FIG. 6. FIG. 6 is a flowchart illustrating a calculation processing procedure by the delivery device 100 according to the first exemplary embodiment.

As illustrated in FIG. 6, in step S101, the receiving unit 132 of the delivery device 100 determines whether the commercial product page is accessed from the terminal device 10. When the commercial product page is not accessed (No in step S101), the receiving unit 132 waits until the commercial product page is accessed.

In contrast, when the commercial product page is accessed from the terminal device 10 (Yes in step S101), the delivery unit 134 delivers the commercial product page to the terminal device 10 in step S102. The storing unit 135 adds “1.” to the number of views of the commercial product corresponding to the commercial product page to update the number of views which is stored in the commercial product information memory unit 121 in step S103.

Next, in step S104, the receiving unit 132 of the delivery device 100 determines whether the commercial product is purchased from the terminal device 10. When the commercial product is not purchased (No in step S104), the receiving unit 132 waits until the commercial product page is accessed.

In contrast, when the commercial product is purchased from the terminal device 10 (Yes in step S104), the storing unit 135 adds “1” to the number of purchases of the commercial product to update the number of purchases which is stored in the commercial product information memory unit 121 in step S105.

Next, in step S106, the calculating unit 131 calculates the evaluation value of the commercial product for every commercial product based on the number of purchases and the number of views. In step S107, the calculating unit 131 stores the calculated evaluation value in the commercial product information memory unit 121. The calculating unit 131 may perform the evaluation value calculation processing described above at any timing. For example, the calculating unit 131 may regularly perform the evaluation value calculation processing (for example, every day or every week) or perform the calculation processing when the commercial product page is accessed.

### 1-5. Delivery Processing Procedure

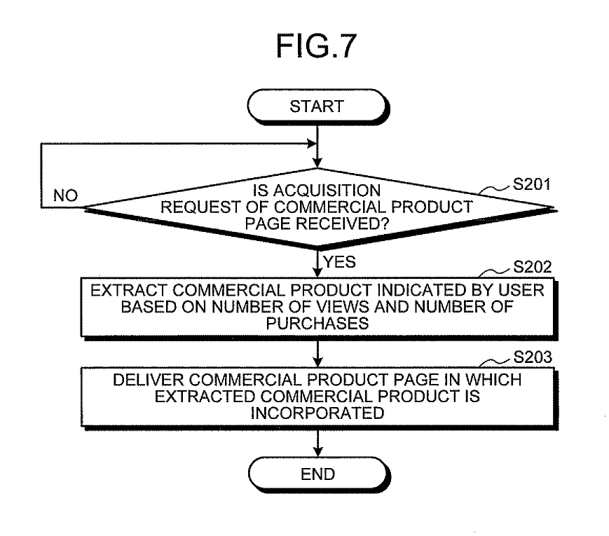

Next, a delivery processing procedure by the delivery device according to the first exemplary embodiment will be described with reference to FIG. 7. FIG. 7 is a flowchart illustrating a delivery processing procedure by the delivery device 100 according to the first exemplary embodiment.

As illustrated in FIG. 7, in step S201, the receiving unit 132 of the delivery device 100 determines whether the acquisition request for the commercial product page is received from the terminal device 10. When the acquisition request for the commercial product page is not received (No in step S201), the receiving unit 132 waits until acquisition request for the commercial product page is received.

In contrast, when the acquisition request for the commercial product page is received (Yes in step S201), the extracting unit 133 extracts the commercial product based on the evaluation value stored in the commercial product information memory unit 121 in step S202.

Next, in step S203, the delivery unit 134 of the delivery device 100 delivers the commercial product page in which the commercial product extracted by the extracting unit 133 is incorporated to the terminal device 10, which is a transmission source of the acquisition request.

### 1-6. Modified Embodiment

The delivery device 100 according to the first exemplary embodiment which has been described above may be carried out by various modified embodiments other than the above exemplary embodiment. Hereinafter, another exemplary embodiment of the delivery device 100 will be described.

1-6-1. Calculation of Evaluation Value

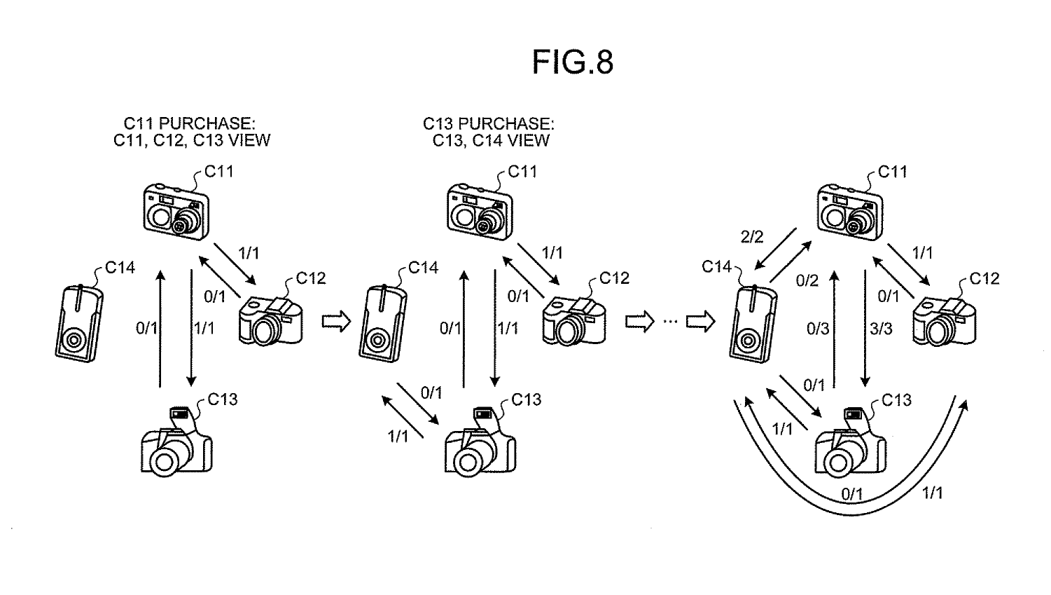

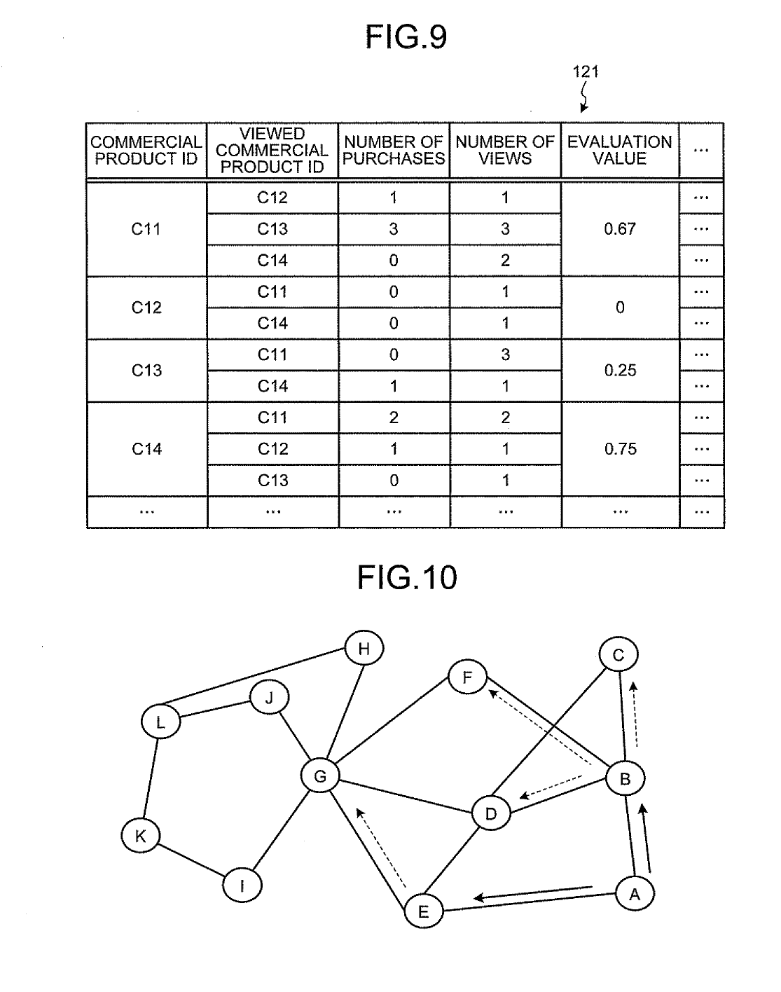

In the above exemplary embodiment, it is described that the number of purchases and the number of views of the commercial product are stored for every commercial product. However, the above-described delivery device 100 may store the number of purchases and the number of views of the commercial product which is not purchased among the commercial product page group which is viewed within a predetermined period so as to associate with the purchased commercial product, which will be described with reference to FIGS. 8 and 9. FIG. 8 is a diagram illustrating an example of evaluation processing according to a modified embodiment. In the example of FIG. 8, it is assumed that the delivery device 100 stores information concerning the commercial products C11 to C14 of the commercial product IDs “C11” to “C14”.

In an example of the left side of FIG. 8, the commercial product page of the commercial product IDs “C11”, “C12”, and “C13” is viewed one time by one user within a predetermined period and the commercial product C11 among the viewed commercial products C11 to C13 is purchased. As illustrated in the left side of FIG. 8, the number of views and the number of purchases are illustrated between the purchased commercial product and the viewed commercial product. For example, in an arrow directed from the commercial product C11 to the commercial product C12, “1/1” indicating that the number of purchases of the commercial product C11 is “1” and the number of views of the commercial product C11 is “1” is illustrated. Here, it is indicated that the two commercial products which are connected by the arrow are simultaneously evaluated. Further, a commercial product which becomes an origin of the arrow indicates that the commercial product is purchased.

In contrast, in an arrow directed from the commercial product C12 to the commercial product C11, “0/1” indicating that the number of purchases of the commercial product C12 is “0” and the number of views of the commercial product C12 is “1” is illustrated. Here, a commercial product which becomes an end point of the arrow indicates that the commercial product is viewed but not purchased.

Further, in an arrow directed from the commercial product C11 to the commercial product C13, “1/1” indicating that the number of purchases of the commercial product C11 is “1” and the number of views of the commercial product C11 is “ ” is illustrated. On the other hand, in an arrow directed from the commercial product C13 to the commercial product C11, “0/1” indicating that the number of purchases of the commercial product C13 is “0” and the number of views of the commercial product C13 is “1” is illustrated.

Further, between the commercial product C12 and the commercial product C13 which are viewed but not purchased, even though the number of purchases of the commercial product C12 and the commercial product C13 is actually “0” and the number of views of the commercial product C12 and the commercial product C13 is “1”, an arrow is not illustrated. However, the exemplary embodiment is not limited to this example, but information on commercial products which are viewed but not purchased may be stored.

In the center of FIG. 8, an example is illustrated in which the commercial product page of the commercial products C13 and C14 is viewed and the commercial product C13 is purchased from the status illustrated in the left side of FIG. 8. As illustrated in the center of FIG. 8, in an arrow directed from the commercial product C13 to the commercial product C14, “1/1” indicating that the number of purchases of the commercial product C13 is “1” and the number of views of the commercial product C13 is “1” is illustrated. On the other hand, in an arrow directed from the commercial product C14 to the commercial product C13, “0/1” indicating that the number of purchases of the commercial product C14 is “0” and the number of views of the commercial product C14 is “1” is illustrated.

In an example of the right side of FIG. 8, from the status illustrated in the center of FIG. 8, the commercial product C12 and the commercial product C14 are viewed and the commercial product C14 is purchased. The commercial products C11, C13, and C14 are viewed and a commercial product 11 is purchased and similarly, the commercial products C11, C13, and C14 are viewed and the commercial product 11 is purchased.

As illustrated in the right side of FIG. 8, in an arrow directed from the commercial product C14 to the commercial product C12, “1/1” indicating that the number of purchases of the commercial product C14 is “1” and the number of views of the commercial product C14 is “1” is illustrated. On the other hand, in an arrow directed from the commercial product C12 to the commercial product C14, “0/1” indicating that the number of purchases of the commercial product C12 is “0” and the number of views of the commercial product C12 is “1” is illustrated. In an arrow directed from the commercial product C14 to the commercial product C11, “0/2” indicating that the number of purchases of the commercial product C14 is “0” and the number of views of the commercial product C14 is “2” is illustrated. On the other hand, in an arrow directed from the commercial product C11 to the commercial product C14, “2/2” indicating that the number of purchases of the commercial product C11 is “2” and the number of views of the commercial product C11 is “2” is illustrated. In an arrow directed from the commercial product C11 to the commercial product C13, “3/3” indicating that the number of purchases of the commercial product C11 is “3” and the number of views of the commercial product C11 is “3” is illustrated. On the other hand, in an arrow directed from the commercial product C13 to the commercial product C11, “0/3” indicating that the number of purchases of the commercial product C13 is “0” and the number of views of the commercial product C13 is “3” is illustrated.

Here, FIG. 9 illustrates an example of the commercial product information memory unit according to the modified embodiment. FIG. 9 illustrates an example of the commercial product information memory unit 121 in the status of the right side of FIG. 8. In an example illustrated in FIG. 9, the commercial product information memory unit 121 includes items of the “commercial product ID”, the “viewed commercial product ID”, the “number of purchases”, the “number of views”, and the “evaluation value”.

The “commercial product ID” indicates identification information for identifying a commercial product. The “viewed commercial product ID” indicates the “commercial product ID” of another commercial product which is viewed in a predetermined period. The “number of purchases” indicates the number of times that a commercial product corresponding to the commercial product ID is purchased so as to be associated with the purchased commercial product among the commercial products of a commercial product page group which is viewed in the predetermined period for every another commercial product which is not purchased. The “number of views” indicates the number of times that a commercial product page corresponding to the commercial product ID is viewed so as to be associated with the purchased commercial product among the commercial products of a commercial product page group which is viewed in the predetermined period for every another commercial product which is not purchased. The “evaluation value” indicates a degree of popularity of the commercial product which is compared with the commercial product corresponding to the viewed commercial product ID. For example, as the evaluation value is higher, the commercial product corresponding to the commercial product ID is easier to be purchased by the user and more popular than the commercial product corresponding to the viewed commercial product ID. The “evaluation value” is calculated, for example, by dividing the total value of the number of purchases in the viewed commercial product ID by the total value of the number of views for each commercial product ID.

In other words, in FIG. 8, in the commercial product identified by the commercial product ID “C11”, the commercial product page corresponding to the viewed commercial product IDs “C12”, “C13”, and “C14” is viewed in a predetermined period. Further, in FIG. 9, the number of purchases is “1” and the number of views is “1” between the commercial product ID “C11” and the viewed commercial product ID “C12”, the number of purchases is “3” and the number of views is “3” between the commercial product ID “C11” and the viewed commercial product ID “C13”, and the number of purchases is “0” and the number of views is “2” between the commercial product ID “C11” and the viewed commercial product ID “C14”, and the evaluation value is “0.67”. Further, in FIG. 8, the evaluation value is rounded off to two decimal places.

Further, the “evaluation value” may be calculated for every commercial product of the viewed commercial product ID so as to be associated with the commercial product of the commercial product ID. For example, the calculating unit 131 calculates the evaluation value between the viewed commercial product ID “C12” and the commercial product ID “C11” such that the evaluation value “1” is calculated by dividing the number of purchases “1” by the number of views “1”. Further, the calculating unit 131 calculates the evaluation value between the viewed commercial product ID “C13” and the commercial product ID “C11” such that the evaluation value “1” is calculated by dividing the number of purchases “3” by the number of views “3”. Furthermore, the calculating unit 131 calculates the evaluation value between the viewed commercial product ID “C14” and the commercial product ID “C11” such that the evaluation value “0” is calculated by dividing the number of purchases “0” by the number of views “2”.

Further, in FIGS. 8 and 9, an example has been described in which one commercial product among the commercial products which are viewed by the user is purchased. However, the exemplary embodiment is also applied to a case where pluralities of commercial products are purchased from the commercial products which are viewed by the user. In this case, for example, the commercial product information memory unit 121 updates the number of purchases and the number of views between the purchased commercial product and a commercial product which is viewed but not purchased without updating the number of purchases and the number of views of the purchased commercial products among the viewed commercial products and the commercial products which are viewed but not purchased. However, the embodiment is not limited to the example, but the commercial product information memory unit 121 may store information on the purchased commercial products among the viewed commercial products or on the commercial products which are viewed but not purchased.

As described above, the delivery device 100 may calculate the evaluation value in the relation with another commercial product which is simultaneously evaluated by calculating the evaluation value after storing the number of purchases and the number of views for every another commercial product which has not been purchased so as to be associated with the purchased commercial product, among the commercial product page group which is viewed in the predetermined period. By doing this, the delivery device 100 may determine the purchased commercial product among the commercial products which are viewed by one user in the predetermined period so that it is possible to determine which commercial product is more popular than other commercial products.

For example, in the example of FIG. 9, when the commercial product C11 is viewed three times together with the commercial product page of the commercial product C13 in the predetermined period, the commercial product is purchased three times in three times of evaluation. Therefore, it is understood that the commercial product C11 is more popular than the commercial product C13. In the meantime, when the commercial product C11 is viewed two times with the commercial product page of the commercial product C14 in the predetermined period, the commercial product C11 is not even once purchased among two times of evaluation. Therefore, it is understood that the commercial product C14 is more popular than the commercial product C1.

1-6-2. Predetermined Period

In the above-described exemplary embodiment, the predetermined period may be a period until the commercial product is currently purchased from a time when the commercial product is previously purchased. For example, when the commercial product page is viewed, while the commercial product is currently purchased from a time when the commercial product is previously purchased, the storing unit 135 updates the number of views the webpage concerning the commercial product and the number of profitable behaviors of the webpage stored in the commercial product information memory unit 121. By doing this, the delivery device 100 may specify the viewed commercial product corresponding to the purchased commercial product.

1-6-3. Viewed Commercial Product

In the above-described exemplary embodiment, the commercial product of the viewed commercial product ID which is stored in the commercial product information memory unit 121 may be limited to another commercial product of the same category which is viewed in the predetermined period. For example, when another commercial product of the commercial product page which is viewed in the predetermined period has the same category as the commercial product of the commercial product ID, the storing unit 135 updates the “viewed commercial product ID”, the “number of purchases”, and the “number of views”. By doing this, the delivery device 100 may calculate an evaluation value between the commercial product of the commercial product ID and another commercial product which is suitable as a comparison object of the commercial product.

1-6-4. Extracting of Commercial Product

In the above-described exemplary embodiment, an example in which the information on the commercial product is extracted in descending order of the evaluation has been described. However, the delivery device 100 may extract the information on the commercial product based on a distance indicating the relation between the commercial products which are viewed in the predetermined period and simultaneously evaluated, which will be described with reference to FIG. 10. FIG. 10 is a diagram illustrating an example of a social graph according to the modified embodiment. FIG. 10 is an example of the social graph illustrating a relation between commercial products of commercial products A to L. Here, an index indicating the relation between the commercial products is a “distance”. Specifically, the “distance” is “1” in the case of the commercial products which are viewed by one user within the predetermined period and simultaneously evaluated. For example, in the example of the left side of FIG. 8, the commercial product C11 is viewed and evaluated simultaneously with the commercial product C13 in the predetermined period, so that the distance is “1”. Further, the “distance” is “2” when a commercial product is not viewed by one user in the predetermined period but is connected via another commercial product. For example, in the example of the left side of FIG. 8, the commercial product C12 is connected with the commercial product C13 through the commercial product C11, so that the distance is “2”.

In the example of FIG. 10, a commercial product A is directly connected with a commercial product B and a commercial product E so that the relation of the distance “1” is formed. Further, in the example of FIG. 10, the commercial product A is connected with the commercial product C through the commercial product B, so that the relation of the distance “2” is formed. In the example of FIG. 10, the commercial product A is connected with a commercial product D, a commercial product F, and a commercial product G through another commercial product so that the relation of the distance “2” is formed. Further, in the example of FIG. 10, the commercial product A is connected with a commercial product H, a commercial product I, and a commercial product J through two other commercial products, so that the relation of the distance “3” is formed. Furthermore, in the example of FIG. 10, the commercial product A is connected with a commercial product L and a commercial product K through three other commercial products, so that the relation of the distance “4” is formed.

Here, the extracting unit 133 extracts a commercial product which is in a predetermined distance from the commercial product of the commercial product page as a commercial product which is displayed in the recommend frame of the commercial product page. For example, the extracting unit 133 extracts another commercial product within a distance “2” from the commercial product of the commercial product page. In this case, the extracting unit 133 extracts the commercial product B and the commercial product E within a distance “1” from the commercial product A and the commercial product C, the commercial product D, the commercial product F, and the commercial product G within a distance “2” from the commercial product A. The extracting unit 133 may extract a commercial product having a high evaluation value among the commercial products within a predetermined distance in priority to others.

As described above, the delivery device 100 extracts the commercial product within a predetermined distance so that a commercial product which is connected through another commercial product is also extracted in addition to another commercial product which is viewed in the predetermined period. Therefore, it is possible to recommend a variety of commercial products to the user.

### 1-7. Effect

As described above, the delivery device 100 according to the first exemplary embodiment includes the storing unit 135, and the calculating unit 131. The storing unit 135 stores the number of views of the commercial product page (corresponding to an example of a webpage of the commercial product) of the commercial product and the number of purchases (corresponding to an example of the number of behaviors which result in profitable behavior) which leads a profit of a provider who provides the commercial product page by the user who accesses the commercial product page in the storing unit for every commercial product. The calculating unit 131 calculates the evaluation value of the commercial product of the user based on the number of views and the number of purchases stored in the storing unit.

By doing this, the delivery device 100 calculates the evaluation value supported by actual behavior of the user so that the commercial product may be appropriately evaluated with a high credibility. That is, the delivery device 100 may increase accuracy of the evaluation value of the commercial product. Further, the delivery device 100 calculates the evaluation value of the commercial product to be lower as the number of being evaluation object is increased so that it is possible to appropriately evaluate the commercial product itself.

Further, in the delivery device 100 according to the exemplary embodiment, the storing unit 135 stores the number of views and the number of purchases of the commercial product page for every another commercial product which is not purchased so as to be associated with the purchased commercial product, among the commercial product group which is viewed in the predetermined period.

By doing this, the delivery device 100 according to the exemplary embodiment may calculate the evaluation value in the relation with another commercial product which is viewed in the predetermined period so that it is possible to determine which one between the commercial product and another commercial product is more popular than the other.

Further, in the delivery device 100 according to the exemplary embodiment, the storing unit 135 updates the number of views and the number of purchases which are stored in the storing unit when the commercial product page is viewed in a predetermined period between the previous purchase and the current purchase.

By doing this, the delivery device 100 according to the exemplary embodiment may specify the viewed commercial product with respect to the purchased commercial product.

Further, in the delivery device 100 according to the exemplary embodiment, the storing unit 135 updates the number of views and the number of behaviors for every commercial product group of the same category which is viewed in the predetermined period.

By doing this, the delivery device 100 according to the exemplary embodiment may calculate the evaluation value between the commercial product and another commercial product which is appropriate as the comparison object of the commercial product.

Further, the delivery device 100 according to the exemplary embodiment further includes the extracting unit 133 and the delivery unit 134. The extracting unit 133 extracts the information on the commercial product based on the number of views and the number of behaviors which are stored in the storing unit. The delivery unit 134 delivers the information on the commercial product extracted by the extracting unit 133 to a terminal device as a comparison object.

By doing this, the delivery device 100 according to the exemplary embodiment may deliver the coamznercial product page in which a commercial product which is a comparison object is incorporated to the terminal device so as to encourage decision-making of the user to purchase a commercial product.

Further, in the delivery device 100 according to the exemplary embodiment, the extracting unit 133 extracts information on another commercial product in descending order of the evaluation value stored in the storing unit.

By doing this, the delivery device 100 according to the exemplary embodiment delivers the commercial product page in which a popular commercial product is incorporated to the terminal device so that purchase motivation of the user is increased.

Further, in the delivery device 100 according to the exemplary embodiment, the extracting unit 133 extracts information on the commercial product based on a distance indicating the relation between the commercial products which are viewed in the predetermined period and simultaneously evaluated.

By doing this, the delivery device 100 according to the exemplary embodiment may extract also the commercial product which is connected through another commercial product in addition to another commercial product which is viewed in the predetermined period and simultaneously evaluated so that it is possible to recommend a variety of commercial products to the user.

### Second Exemplary Embodiment

In a second exemplary embodiment, a processing that receives a reason for purchasing the commercial product from the terminal device and delivers a commercial product page in which information on the extracted commercial product and the reason for reception are incorporated to the terminal device 10 will be described. Further, a configuration of a delivery system is the same as the example illustrated in FIG. 1 so that the description thereof will not be provided.

### 2-1. Configuration of Delivery Device

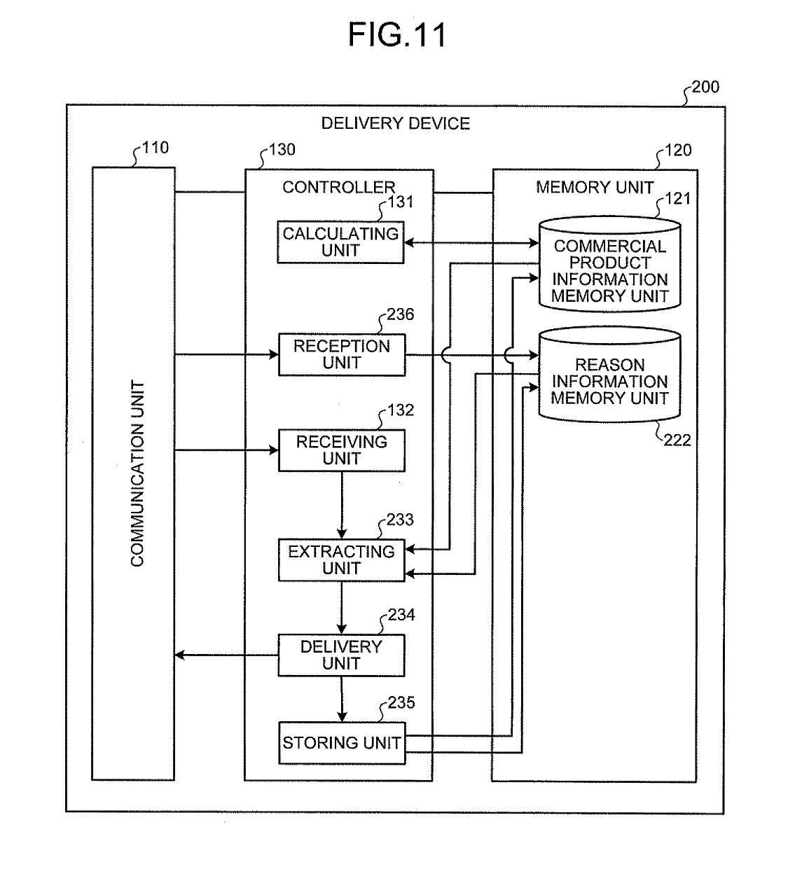

First, a configuration of a delivery device according to a second exemplary embodiment will be described with reference to FIG. 11. FIG. 11 is a diagram illustrating a configuration example of a delivery device 200 according to the second exemplary embodiment. As illustrated in FIG. 11, the delivery device 200 further includes a reason information memory unit 222 and a reception unit 236 as compared with the delivery device 100.

Regarding Reason Information Memory Unit 222

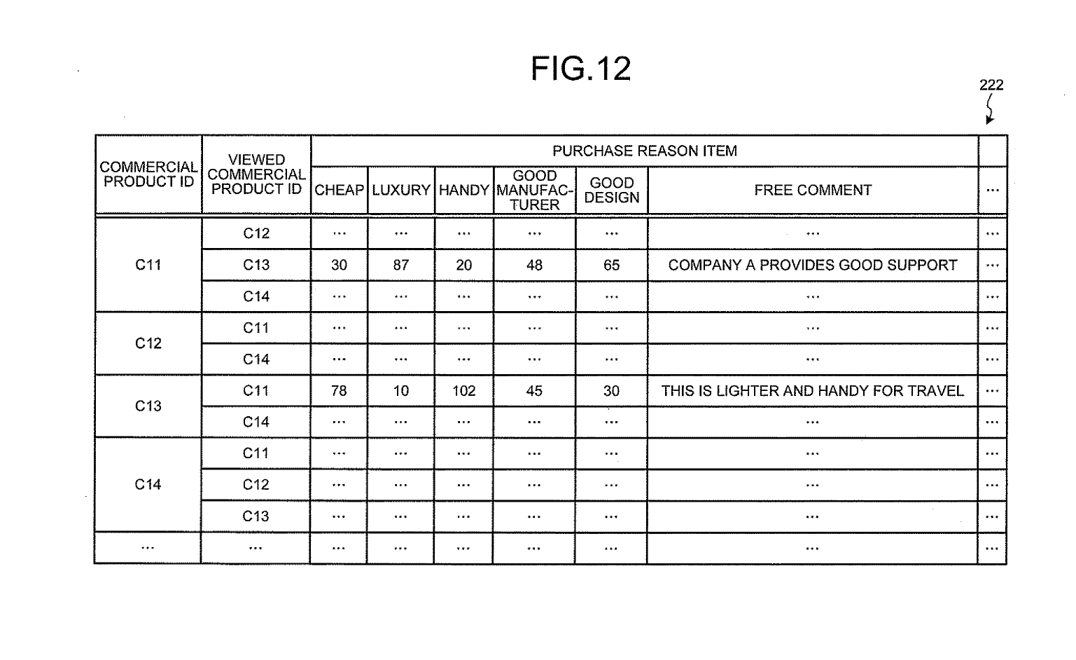

The reason information memory unit 222 stores various pieces of information on a reason for purchasing a commercial product. For example, the reason information memory unit 222 stores a number in which various purchasing reasons are selected by the user for every commercial product. Here, in FIG. 12, an example of the reason information memory unit according to the second exemplary embodiment will be described. As illustrated in FIG. 12, the reason information memory unit 222 has items of a “commercial product ID”, a “viewed commercial product ID”, and a “purchase reason item”.

The “commercial product ID” indicates identification information for identifying the commercial product. The “viewed commercial product ID” indicates a “commercial product ID” of the commercial product which is viewed in a predetermined period”. The “purchasing reason item” is the number in which various reasons of purchasing the commercial product of the “commercial product ID” are selected by the user as compared with the commercial product of the “viewed commercial product ID”. As illustrated in FIG. 12, the “purchase reason item” may include, for example, items such as “cheap”, “luxury”, “handy”, “good manufacturer”, “good design”, and “free comment”. Further, in the various items such as “cheap”, “luxury”, “handy”, “good manufacturer”, and “good design”, a total number in which these items are selected by the user as the purchasing reason is stored. In the “free comment”, a character string input by the user is stored.

Further, the “purchasing reason item” is determined based on a category of the commercial product. Further, the delivery device 200 reflects the purchasing reason which is received from the terminal device in the reason information memory unit 222 whenever the user purchases the commercial product.

That is, in FIG. 12, when the commercial product of the commercial product ID “C11” is compared with the commercial product of the viewed commercial product ID “C13”, 30 times of “cheap”, 87 times of “luxury”, 20 times of “handy”, 48 times of “good manufacturer”, 65 times of “good design” are selected by the user. Further, in FIG. 12, as a “free comment”, an example in which “company A provides good support” is input by the user is provided.

Regarding Reception Unit 236

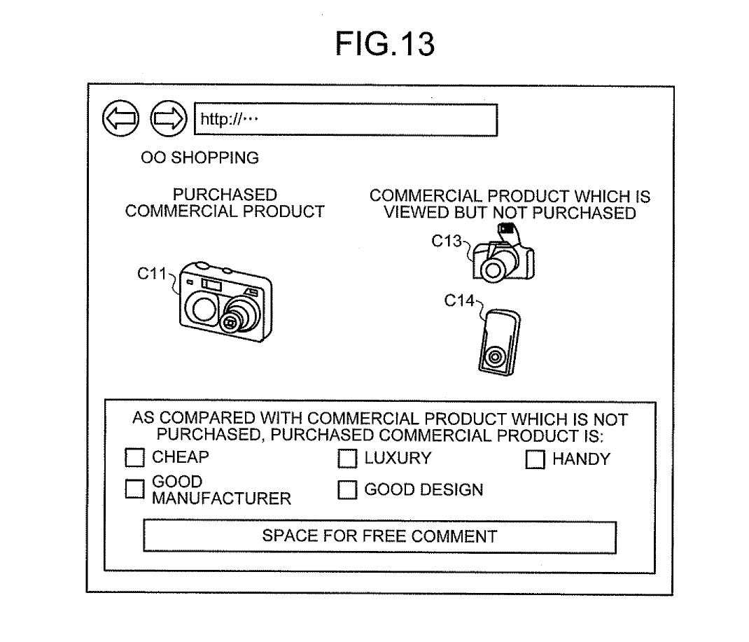

The reception unit 236 receives a reason of purchasing the commercial product from the terminal device 10. Specifically, the reception unit 236 receives the information input on the purchasing reason item which is displayed on a reception screen. FIG. 13 is a diagram illustrating an example of a reception screen according to the second exemplary embodiment. Here, it is assumed that the commercial products C11, C13, and C14 are viewed by one user and the commercial product C11 is purchased by the same user. In this case, as illustrated in FIG. 13, in the reception screen, the commercial product C11 is displayed as a purchased commercial product. Further, as illustrated in FIG. 13, in the reception screen, the commercial products C13 and C14 are displayed as a commercial product which is viewed but not purchased.

Further, as illustrated in FIG. 13, in the reception screen, check boxes of the various items such as “cheap”, “luxury”, “handy”, “good manufacturer”, and “good design” are provided. By doing this, when the user inputs check marks in the check boxes corresponding to the purchasing reason of the purchased commercial product as compared with the commercial product which is not purchased, the reception unit 236 receives the purchasing reason.

Further, as illustrated in FIG. 13, in the reception screen, a text box capable of inputting a comment for the “free comment” which is the “purchasing reason item” is provided. By doing this, the user may input the purchasing reason of the commercial product which is purchased as compared with the commercial product which is not purchased so that the reception unit 236 receives a comment for the purchasing reason. Further, in the reception screen, as illustrated in FIG. 13, the commercial product C11 which is purchased by the user and the commercial products C13 and C14 which are viewed but not purchased are displayed.

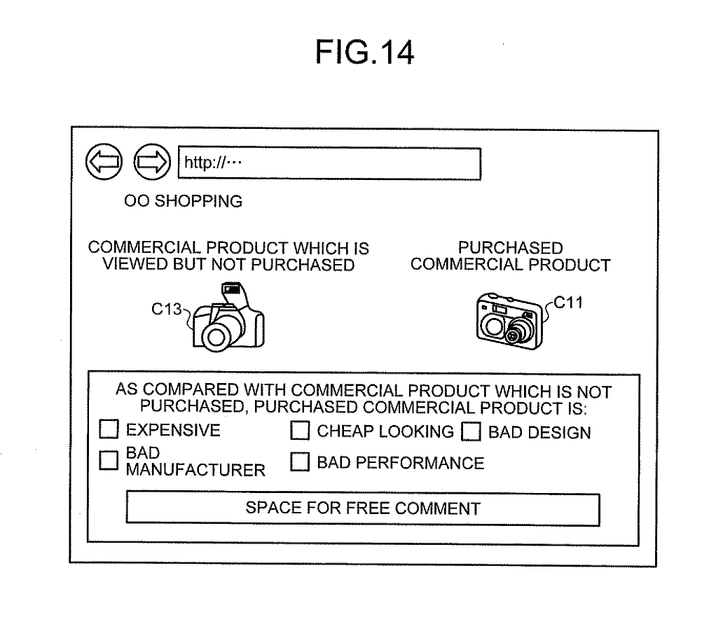

The reception screen may receive a information indicating the reason why the user does not purchase the commercial product as compared with the commercial product which is not purchased by the user. Further, the commercial product which is displayed in the reception screen as the commercial product which is not purchased may be randomly extracted from the commercial products which are not purchased among the commercial products which are simultaneously evaluated or all of the commercial products are sequentially extracted. FIG. 14 is a diagram illustrating an example of the reception screen according to the second exemplary embodiment. Here, it is assumed that the commercial products C11, C13, and C14 are viewed by one user and the commercial product C11 is purchased by the same user. Further, it is assumed that as the commercial product which is not purchased by the user and displayed in the reception screen, the commercial product C13 is extracted. In this case, as illustrated in FIG. 14, in the reception screen, as the commercial product which is viewed but not purchased, the commercial product C13 is displayed. Further, as illustrated in FIG. 14, in the reception screen, as the purchased commercial product, the commercial product C11 is displayed.

Further, as illustrated in FIG. 14, in the reception screen, as a reason why the commercial product is not purchased, check boxes of the various items such as “expensive”, “cheap-looking”, “bad design”, “bad manufacturer”, and “bad performance” may be provided.

Regarding Extracting Unit 233

When the acquisition request for the commercial product page is received by the receiving unit 132, the extracting unit 233 extracts information on product from the commercial product information memory unit 121 based on the evaluation value calculated by the calculating unit 131. Further, when the acquisition request for the purchasing reason of the commercial product is received by the receiving unit 132, the extracting unit 233 extracts information on the purchasing reason of the commercial product from the reason information memory unit 222. Specifically, when the commercial product which is displayed in the ranking frame or the recommend frame of the commercial product page is clicked, the extracting unit 233 extracts the purchasing reason item corresponding to the clicked commercial product. For example, the extracting unit 233 extracts numerical values of highly ranked three purchasing reason items and a comment of the free comment.

When the commercial product C13 which is displayed in the ranking frame or the recommend frame of the commercial product page is clicked, the extracting unit 233 extracts items and numerical values of “luxury”, “good design”, and “good manufacturer” in which numerical values of the purchasing reason items are ranked in top three, in which the commercial product ID is “C11” and the viewed commercial product ID is “C13”, and the free comment item of “company A provides good support”. Further, the extracting unit 233 extracts items and numerical values of “handy”, “cheap”, and “good manufacturer” in which numerical values of the purchasing reason items are ranked in top three, in which the commercial product ID is “C11” and the viewed commercial product ID is “C13” and the free comment item of “this one is lighter and handy for the travel”.

Further, the extracting unit 233 may extract an arbitrary number of purchasing reason items and a plurality of comments without being limited to highly ranked three purchasing reason items and one comment of the free comment.

Further, the extracting unit 233 may extract the commercial product in descending order of the numerical value of the various purchasing reason items such as “cheap”, “luxury”, and “good design” as the commercial product which is displayed in the recommend frame. For example, the extracting unit 233 extracts the commercial product in which numerical value of the purchasing reason item “cheap” is ranked in top three. By doing this, three commercial products in which “cheap” is highly evaluated by the user are displayed in the recommend frame, so that it is possible to increase purchasing motivation of the user who emphasizes the importance of low cost of the commercial product.

Regarding Delivery Unit 234

The delivery unit 234 delivers the commercial product page in which the commercial product extracted by the extracting unit 233 is incorporated to the terminal device 10 which is a transmission source of the acquisition request received by the receiving unit 132. When the acquisition request of the purchasing reason of the commercial product is received by the receiving unit 132, the delivery unit 234, delivers a comparison page in which information on the purchasing reason of the commercial product extracted by the extracting unit 233 is incorporated to the terminal device 10. Specifically, when the commercial product which is displayed in the ranking frame or the recommend frame of the commercial product page is clicked, the delivery unit 234 delivers the comparison page in which the numerical value and the comment of the purchasing reason item which are extracted by the extracting unit 233 is displayed to the terminal device 10.

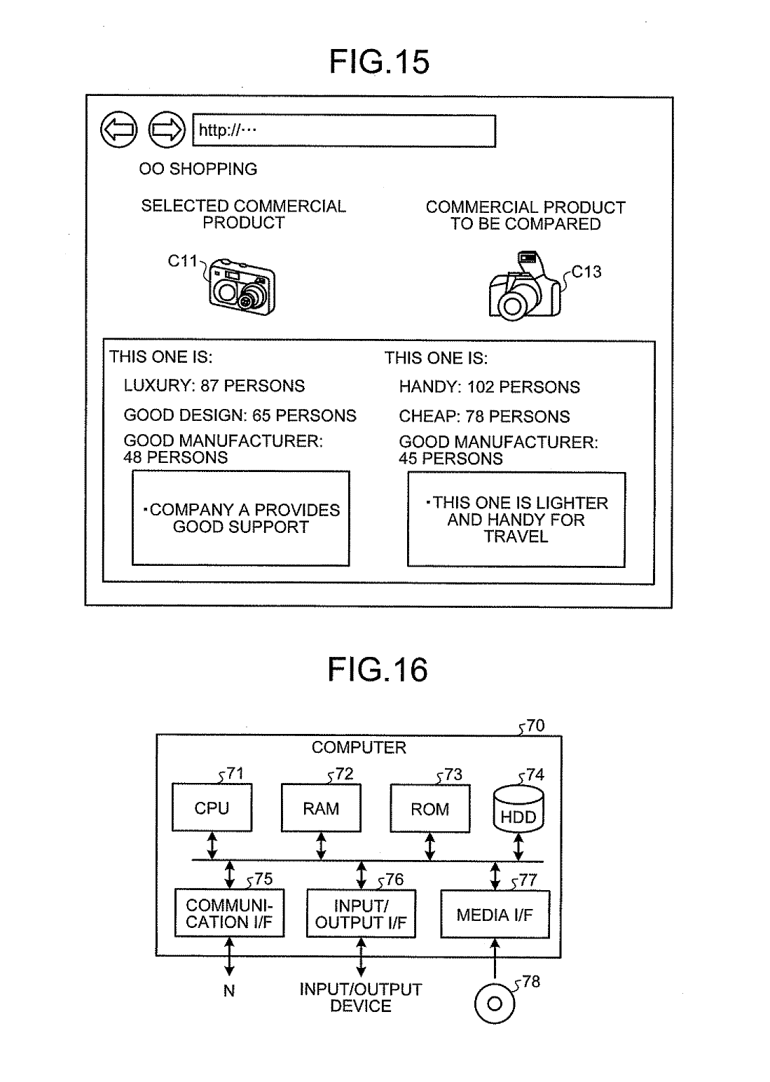

This will be described using FIGS. 5 and 15. FIG. 15 is a diagram illustrating an example of the comparison page according to the second exemplary embodiment. For example, when the commercial product C13 which is displayed in the ranking frame of the commercial product page illustrated in FIG. 5 is clicked, the delivery device 200 delivers the comparison page of the commercial product C13 and the commercial product C11.

In the example of FIG. 15, the commercial product C11 which is handled by the commercial product page, the commercial product C13 which is clicked in the commercial product page are displayed in the comparison page. Further, in the comparison page, items and numerical values of “luxury”, “good design”, and “good manufacturer” of the commercial product C11 extracted by the extracting unit 233 and “company A provides good support” of the free comment item are displayed. Further, in the comparison page, items and numerical values of “handy”, “cheap”, and “good manufacturer” of the commercial product C13 extracted by the extracting unit 233 and “this one is lighter and handy for the travel” of the free comment item are displayed.

In the comparison page, an arbitrary number of purchasing reason items and a plurality of comments extracted by the extracting unit 233 may be displayed.

Regarding Storing Unit 235

The storing unit 235 updates information which is stored in the commercial product information memory unit 121. Further, the storing unit 235 updates information stored in the reason information memory unit 222. Specifically, whenever the purchasing reason is received by the reception unit 236, the storing unit 235 updates the purchasing reason item stored in the reason information memory unit 222. For example, the storing unit 235 adds a numerical value of the purchasing reason item corresponding to the purchasing reason received by the reception unit 236 to update the purchasing reason item.

### 2-2. Effect

As described above, the delivery device 200 according to the second exemplary embodiment further includes the reception unit 236 and the delivery unit 234. The reception unit 236 receives a reason why the user purchases the commercial product. The delivery unit 234 delivers information on the commercial product extracted by the extracting unit 233 and the comparison page in which the reason received by the reception unit 236 is incorporated to the user.

By doing this, the delivery device 200 according to the second exemplary embodiment may deliver a comparison page capable of comparing with other commercial product so that it is possible to increase a purchasing motivation of the user.

Further, in the delivery device 200 according to the exemplary embodiment, the reception unit 236 receives reason why the commercial product page is viewed but the commercial product is not purchased. The delivery unit 234 delivers information on the commercial product extracted by the extracting unit 233 and the comparison page in which the reason received by the reception unit 236 is incorporated to the user.

By doing this, the delivery device 200 according to the exemplary embodiment may deliver a comparison page to understand why the commercial product is not purchased so that reference information for purchasing a commercial product may be provided to the user.

### 3. Others

Among the processes which have been described in the above exemplary embodiment, all or a part of the processing which have been described to be automatically performed may be manually performed, alternatively, all or a part of the processing which have been described to be manually performed may be automatically performed by using a known method. Besides this, information including processing procedure, specific name, various types of data or parameter described in the above specification or the drawings may be arbitrarily modified if not specifically mentioned.

Further, components of each device illustrated in the drawings are functional and conceptual but are not necessarily needed to have a physically illustrated configuration. In other words, the distribution and integration of specific configuration for each device is not limited to those illustrated in the drawing, but all or a part of them may be functionally or physically distributed or integrated in an arbitrary unit in accordance with various loads or usage circumstances.

For example, the commercial product information memory unit 121 illustrated in FIG. 3 may be held in a storage server instead of the delivery device 100 and the delivery device 200. In this case, the delivery device 100 may access the storage server to obtain information on the commercial product.

Further, the delivery device 100 and the delivery device 200 may be an operating device which performs only the calculating processing by the calculating unit 131 without performing the extraction processing of the commercial product. In this case, the calculating device does not include at least the receiving unit 132, the extracting unit 133, and the delivery unit 134. The delivery device which includes the receiving unit 132, the extracting unit 133, and the delivery unit 134 extracts the commercial product based on the evaluation value of the commercial product calculated by the calculating device. Further, the delivery device 100 and the delivery device 200 may be an extracting device which only performs the extraction processing by the extracting unit 133 without performing the delivery processing of the commercial product page. In this case, the extracting device does not have at least the delivery unit 134. The delivery device which includes the delivery unit 134 delivers the commercial product page in which the commercial product extracted by the extracting device is incorporated to the terminal device 10.

Further, the delivery device 100 according to the first exemplary embodiment and the delivery device 200 according to the second exemplary embodiment are implemented by a computer 70 having a configuration illustrated in FIG. 16. FIG. 16 is a hardware configuration diagram illustrating an example of the computer 70 which implements functions of the delivery device 100 and the delivery device 200. The computer 70 includes a CPU 71, a RAM 72, a read only memory (ROM) 73, a hard disk drive (HOD) 74, a communication interface (I/F) 75, an input/output interface (I/F) 76, and a media interface (I/F) 77.

The CPU 71 operates based on the program stored in the ROM 73 or the HDD 74 and performs various control. The ROM 73 stores a boot program which is executed by the CPU 71 when the computer 70 activates a program which depends on a hardware of the computer 70 or the like.

The HOD 74 stores a program which is executed by the CPU 71, the data which is used by the program, and the like. The communication interface 75 receives data from other equipment through a communication line N to transmit the data to the CPU 71 and transmit data generated by the CPU 71 to other equipment through the communication line N.

The CPU 71 controls output devices such as a display or a printer through the input/output interface 76 and an input device such as a keyboard or a mouse. The CPU 71 acquires data from the input device through the input/output interface 76. Further, the CPU 71 outputs the generated data to the output device through the input/output interface 76.

The media interface 77 reads out the program or the data stored in a recording medium 78 and provides the program or the data to the CPU 71 through the RAM 72. The CPU 71 loads the program from the recording medium 78 onto the RAM 72 through the media interface 77 and executes the loaded program. The recording medium 78 is, for example, an optical recording medium such as a digital versatile disc (DVD) or a phase change rewritable disk (PD) or a magneto-optic recording medium such as a magneto-optical disk (MO), a tape medium, a magnetic recording medium, or a semiconductor memory.

When the computer 70 serves as the delivery device 100 according to the first exemplary embodiment, the CPU 71 of the computer 70 executes the program loaded on the RAM 72 to implement the functions of the calculating unit 131, the receiving unit 132, the extracting unit 133, the delivery unit 134, and the storing unit 135. Further, data in the commercial product information memory unit 121 is stored in the HOD 74.

When the computer 70 serves as the delivery device 200 according to the second exemplary embodiment, the CPU 71 of the computer 70 executes the program loaded on the RAM 72 to implement the functions of the calculating unit 131, the reception unit 236, the receiving unit 132, the extracting unit 233, the delivery unit 234, and the storing unit 235. Further, data in the commercial product information memory unit 121 and the reason information memory unit 222 is stored in the HDD 74.

The CPU 71 of the computer 70 reads out the programs from the recording medium 78 to execute the program, but the program may be obtained from other devices through a communication line N as another example.

Further, the above-described delivery device 100 and the delivery device 200 may be implemented by a plurality of sever computers, or may be implemented by calling an external platform using an API (application programming interface) or a network computing depending on the function so that the configuration may be flexibly changed.

Further, unit (section, module, or unit) disclosed in the claims may be switched into a “means”, a “circuit”, or the like. For example, the calculating unit may be switched into the calculating means or the calculating circuit.

According to an aspect of an exemplary embodiment, it is possible to increase an accuracy of evaluating a commercial product.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An evaluation calculating device, comprising:
a storing unit configured to store a number of views a webpage concerning a commercial product and a number of behaviors which result in profitable behavior which leads a profit of a provider who provides the webpage by the user who accesses the webpage in a memory unit for every commercial product; and
a calculating unit configured to calculate an evaluation value of the commercial product based on the number of views the webpage concerning the commercial product and the number of behaviors of the webpage stored in the memory unit.

2. The evaluation calculating device according to claim 1, wherein the storing unit stores the number of views the webpage concerning the commercial product and the number of profitable behaviors of the webpage for every another commercial product in another webpage in which there is no profitable behavior so as to be associated with the commercial product in the webpage where there is the profitable behavior among a webpage group which is viewed in a predetermined period.

3. The evaluation calculating device according to claim 2, wherein the storing unit updates the number of views and the number of behaviors which are stored in the memory unit in the predetermined period between the previous profitable behavior and the current profitable behavior.

4. The evaluation calculating device according to claim 1, wherein the storing unit updates the number of views and the number of behaviors for every commercial product group in the same category viewed in a predetermined period.

5. The evaluation calculating device according to claim 2, wherein the storing unit updates the number of views and the number of behaviors for every commercial product group in the same category viewed in a predetermined period.

6. The evaluation calculating device according to claim 1, further comprising:
an extracting unit configured to extract information on a commercial product based on the number of views and the number of behaviors stored in the memory unit; and
a delivery unit configured to deliver the information on the commercial product extracted by the extracting unit to a terminal device as a comparison object.

7. The evaluation calculating device according to claim 2, further comprising:
an extracting unit configured to extract information on a commercial product based on the number of views and the number of behaviors stored in the memory unit; and
a delivery unit configured to deliver the information on the commercial product extracted by the extracting unit to a terminal device as a comparison object.

8. The evaluation calculating device according to claim 6, wherein the extracting unit extracts the information on the commercial product indicated by a webpage concerning another commercial product in descending order of an evaluation value stored in the memory unit.

9. The evaluation calculating device according to claim 6, wherein the extracting unit extracts the information on the commercial product based on a distance indicating a relation between the commercial products which are viewed and simultaneously evaluated in a predetermined period.

10. The evaluation calculating device according to claim 6, further comprising:
a reception unit configured to receive a information indicating a reason which results in a profitable behavior from the terminal device,
wherein the delivery unit delivers the information on the commercial product extracted by the extracting unit and the information indicating the reason received by the reception unit.

11. The evaluation calculating device according to claim 7, further comprising:
a reception unit configured to receive a information indicating a reason which results in a profitable behavior from the terminal device,
wherein the delivery unit delivers the information on the commercial product extracted by the extracting unit and the information received by the reception unit.

12. The evaluation calculating device according to claim 10, wherein the reception unit receives the information indicating the reason which does not result in the profitable behavior when a webpage concerning the commercial product is viewed, and
the delivery unit delivers the information on the commercial product extracted by the extracting unit and the information received by the reception unit.

13. The evaluation calculating device according to claim 11, wherein the reception unit receives the information indicating the reason which does not result in the profitable behavior when a webpage concerning the commercial product is viewed, and
the delivery unit delivers the information on the commercial product extracted by the extracting unit and the information received by the reception unit.

14. An evaluation calculating method for causing an evaluation calculating device to perform a process, the process comprising:
storing a number of views a webpage concerning a commercial product and a number of behaviors which result in profitable behavior which leads a profit of a provider who provides the webpage by the user who accesses the webpage in a memory unit for every commercial product; and
calculating an evaluation value of the commercial product based on the number of views the webpage concerning the commercial product and the number of behaviors of the webpage stored in the memory unit.

15. The evaluation calculating method according to claim 14, wherein the storing process is to store the number of views the webpage concerning the commercial product and the number of profitable behaviors of the webpage for every another commercial product in another webpage in which there is no profitable behavior so as to be associated with the commercial product in the webpage where there is the profitable behavior among a webpage group which is viewed in a predetermined period.

16. The evaluation calculating method according to claim 15, wherein the storing process is to update the number of views and the number of behaviors which are stored in the memory unit in the predetermined period between the previous profitable behavior and the current profitable behavior.

17. A non-transitory recording medium having stored therein an evaluation calculating program for causing a computer to execute a process, the process comprising:
storing a number of views a webpage concerning a commercial product and a number of behaviors which result in profitable behavior which leads a profit of a provider who provides the webpage by the user who accesses the webpage in a memory unit for every commercial product; and
calculating an evaluation value of the commercial product based on the number of views the webpage concerning the commercial product and the number of behaviors of the webpage stored in the memory unit.

18. The recording medium according to claim 17, wherein the storing process is to store the number of views the webpage concerning the commercial product and the number of profitable behaviors of the webpage for every another commercial product in another webpage in which there is no profitable behavior so as to be associated with the commercial product in the webpage where there is the profitable behavior among a webpage group which is viewed in a predetermined period.

19. The recording medium according to claim 18, wherein the storing process is to update the number of views and the number of behaviors which are stored in the memory unit in the predetermined period between the previous profitable behavior and the current profitable behavior.
